(19) United States
(12) Patent Application Publication
(10) Pub. No.: US 2019/0317544 A1
(43) Pub. Date: Oct. 17, 2019

(54) HAPTIC KNOB, IN PARTICULAR FOR AN ELECTRIC OR ELECTRONIC APPARATUS, FOR EXAMPLE A HOUSEHOLD APPLIANCE

(71) Applicant: ELBI INTERNATIONAL S.P.A., Torino (IT)

(72) Inventors: Paolo Ravedati, Moncalieri (TO) (IT); Paolo DA PONT, Torino (IT); Marco Becchio, Carignano (TO) (IT); Matteo Chiapparino, Alpignano (TO) (IT)

(21) Appl. No.: 16/465,647

(22) PCT Filed: Nov. 30, 2017
(86) PCT No.: PCT/IB2017/057521

§ 371 Date: May 31, 2019

(30) Foreign Application Priority Data
Dec. 2, 2016 (IT) 102016000122651

(51) Int. Cl. G05G 5/03; F16F 9/53; G05G 1/10

(52) U.S. Cl. CPC G05G 5/03; G05G 2505/00; G05G 1/10; F16F 9/535

(57) ABSTRACT

A knob includes a support structure defining a chamber containing magnetorheological fluid. A holding element is supported and guided by the support structure to be rotated and pressed by the user. A movable portion is rotatably supported by the support structure and is rotatably controlled by the holding element. A switching member moves between rest and work positions when the holding element is pressed. A sensor detects the angular position of the movable portion. A haptic feedback assembly in the chamber acts upon the movable portion to provide haptic stimulation in response to action of the user. A generating apparatus emits a magnetic field with an intensity affecting viscosity of the fluid so the assembly exerts a force upon the movable portion. A control device determines the intensity of the magnetic field depending on predetermined or programmable criteria that are based on angular position and/or arrangement.

### DESCRIPTION

### Technical Field

The invention relates to a knob, in particular for electric or electronic apparatus, for example for a household appliance.

### Technological Background

In numerous technical fields, knobs are used to set or select some functions in different types of devices.

These knobs typically comprise a movable portion, which is configured to be rotated by the action of a user, who holds it in a proper holding element.

One of the advantages of using knobs lies in the fact that they permit a more accurate control compared to other types of control members, such as buttons or switches, which are often based on an “on/off” working principle.

In particular for this reason, knobs are largely used in electric or electronic apparatus of different types. For example, these knobs can be used in household appliances, especially in a washing machine, where it is needed to select or adjust different parameters concerning the washing cycle, such as for example the duration, the type of washing, etc.

### SUMMARY OF THE INVENTION

An object of the invention is to provide a knob, in particular for an electric or electronic apparatus, the knob being of an improved type

In particular, according to the invention, a knob is provided, which is capable of giving a haptic feedback to a user operating it and, at the same time, can be produced in a simple and low-cost manner.

According to the invention, this and other objects are reached by means of a knob having the technical features set forth in the appended independent claim.

The appended claims are an integral part of the technical teaches provided in the following detailed description concerning the invention. In particular, the appended dependent claims define some preferred embodiments of the invention and describe optional technical features thereof.

Further features and advantages of the invention will be best understood upon perusal of the following detailed description, which is provided by way of example and is not limiting, with reference, in particular, to the accompanying drawings, which are briefly described below.

### BRIEF DESCRIPTION OF THE DRAWINGS

FIG. 1 is an axial sectional view of a knob according to an embodiment of the invention.

FIG. 2 is an exploded perspective view of the knob shown in FIG. 1.

FIG. 3 is a partial perspective view of the knob shown in FIGS. 1 and 2.

FIGS. 4, 5 and 6 are views of groups of some components of the knob shown in the preceding figures.

FIG. 6a is a plan view of components of the knob shown in the preceding figures.

FIG. 7 is an axial sectional view of a knob according to a further embodiment of the invention.

FIG. 8 is an exploded perspective view of the knob shown in FIG. 7.

FIGS. 9 to 11 are perspective views of groups of components of the knob shown in FIGS. 7 and 8.

FIG. 12 is an axial sectional view of a knob according to a further embodiment of the invention.

FIGS. 13 and 14 are perspective views of groups of components of the knob shown in FIG. 12.

### DETAILED DESCRIPTION OF THE INVENTION

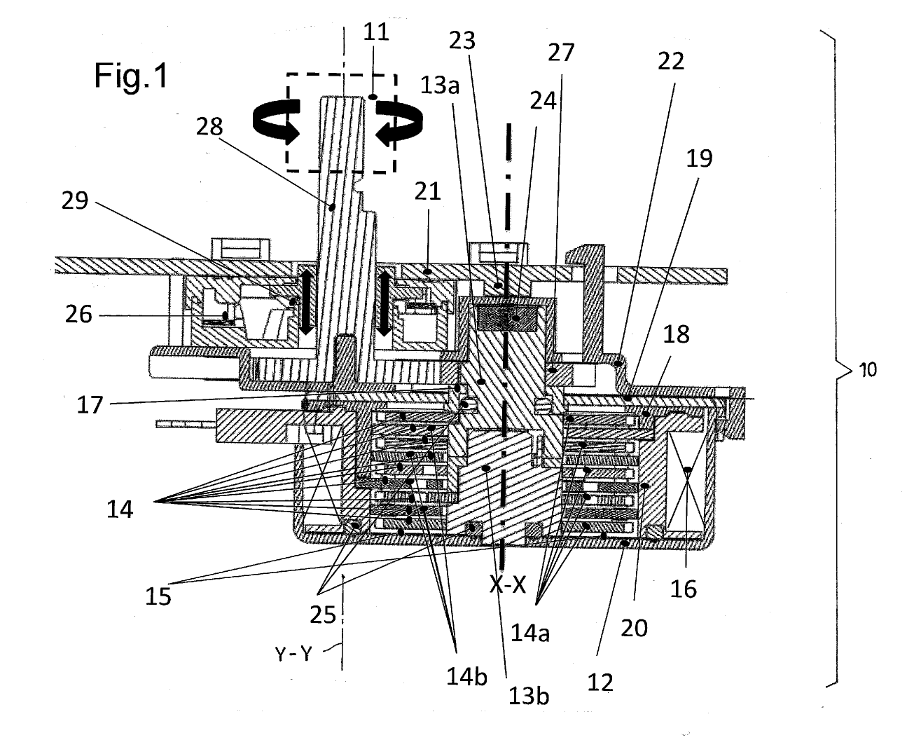

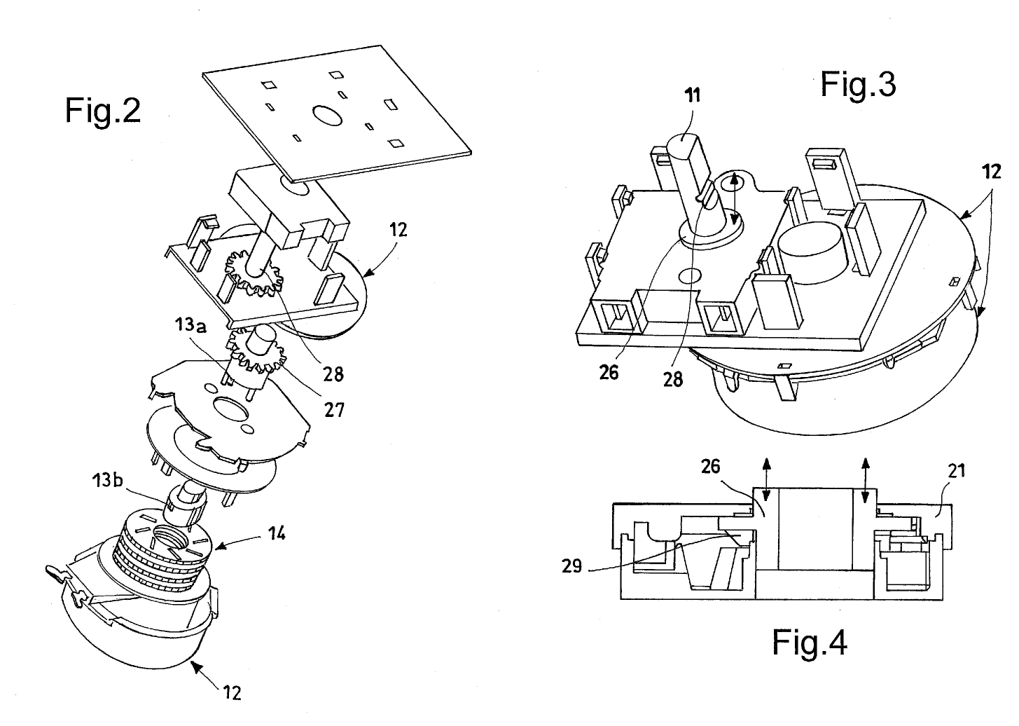

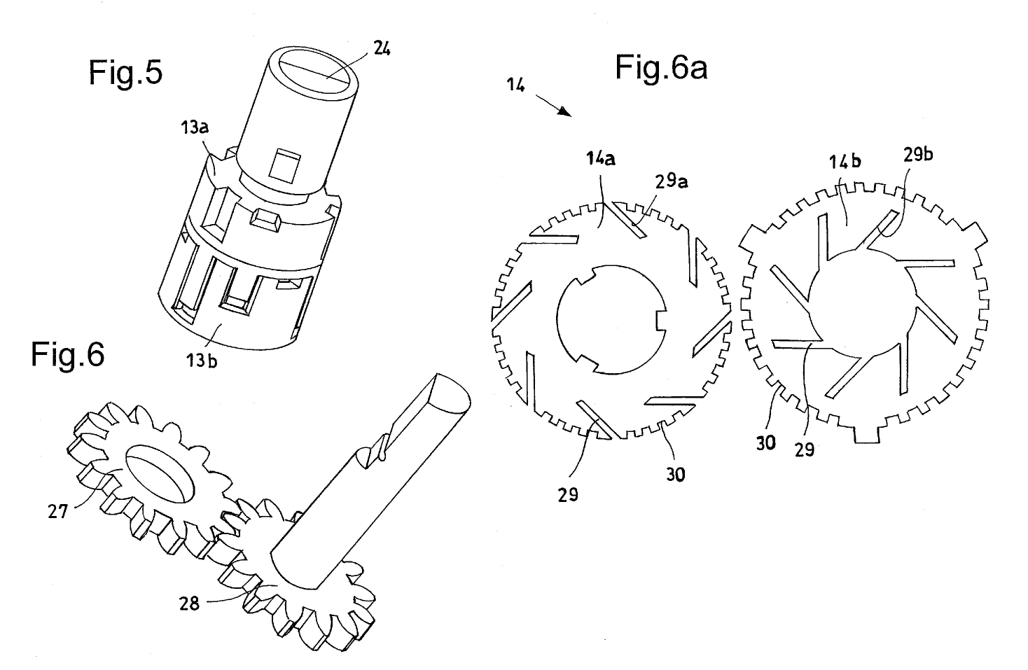

With reference, in particular, to FIGS. 1 to 6 and 6a, number 10 indicates, as a whole, a knob according to an explanatory embodiment of the invention.

As you will better understand from the following detailed description, a knob according to the invention is designed to be mounted on different electric or electronic apparatuses. More in detail, the knob can be installed on (or be integrated in) an interface structure carried by the electric or electronic apparatus.

By way of non-limiting example, the knob according to the invention can be used in a household appliance, in particular a washing machine and, more in particular, a laundry machine. Clearly, the knob can also be applied to different types of household appliances, for example a dishwasher, a fridge, an oven, a microwave oven, gas and induction cookers, small household appliances, such as mixers or food processors, vacuum cleaners. However, the application to household appliances cannot not be considered as the only field in which the invention can be used. As a matter of fact, the knob can also be applied, for example, to electronic devices, such as remote controls, radios and hi-fi systems.

In the embodiment shown, as we will better explain in the description below, knob 10 is configured to be rotated and also pressed by a user in order to control functions and/or the apparatus with which said knob is associated. By way of example, the rotation of knob 10 can correspond to an adjustment or a selection of a function, whereas the pressing of knob 10 can correspond to the consent to or the activation of the adjustment or function that was previously selected through the rotation.

With reference, in particular, to FIG. 1, knob 10 comprises a support structure, for example a casing 12 (in particular, made of a ferromagnetic material), and a movable portion, for example a shaft 13 (in particular, made of a non-ferromagnetic material.

Shaft 13 is supported, in its rotation, by casing 12 around a longitudinal axis X-X and is designed to be rotated by the action of a user.

In this embodiment, the rotation of shaft 13 is carried out by a user, who takes hold of and manually rotates a holding element 11, which is supported, in its rotation, by casing 12. In particular, holding element 11 and shaft 13 are a pair of elements that are separate from one another, but cooperate with one another.

Preferably, holding element 11 and shaft 13 cooperate by means of a gear, for example a pair of toothed gears 27 and 28.

In particular, input toothed gear 28 is connected to holding element 11 (for example, by means of a cotter) and an output toothed gear 27 is connected to shaft 13 (for example, through lap joints). In particular, toothed gears 27 and 28 mesh with one another in the area of their periphery.

In this embodiment, holding element 11 is mounted so as to rotate around a longitudinal axis Y-Y, which is substantially parallel to the longitudinal axis X-X.

In this embodiment, input toothed gear 28 is fixed to a rear portion of holding element 11, whereas output toothed gear 27 is fixed to a front portion of shaft 13.

The rotation of shaft 13 into a predetermined angular position usually corresponds to the selection of an operating mode or to the adjustment of an operating parameter of the apparatus where knob 10 is installed.

Furthermore, knob 10 comprises a haptic feedback assembly, which is indicated as a whole with number 14 and is housed in a chamber 15 defined by casing 12. Chamber 15 contains a magnetorheological fluid and is at least partly crossed by shaft 13, which, therefore, is at least partially in contact with the magnetorheological fluid.

By means of as known method, magnetorheological fluids have a viscosity that can change depending on a magnetic field acting upon them. As we will better explain hereinafter, a part of assembly 14 is configured to act upon shaft 13 so as to provide a haptic stimulation is response to the action of the user.

Knob 10 comprises a magnetic field generating apparatus, in particular an inductor or a solenoid 16, which is configured to generate a magnetic field whose intensity is capable of affecting the viscosity of magnetorheological fluid 15 in such a way that assembly 14 exerts a reaction force upon shaft 13. Solenoid 16 is mounted so as to be substantially coaxial to the axis X-X of shaft 13.

The knob further comprises two constraining apparatus 17 and 18, which are configured to axially lock assembly 14. These apparatus are coaxial to the axis X-X of shaft 13.

Furthermore, knob 10 comprises a control device, for example a printed circuit board (or PCB) 21, which is configured to control solenoid 16, determining the intensity of the aforesaid magnetic field depending on predetermined or programmable criteria.

Therefore, knob 10 is capable of providing a haptic response that can be adjusted in a variable manner and depending on the context.

In this embodiment, assembly 14 further comprises a plurality of ferromagnetic discs 14a, 14b, which are shown in FIG. 6. Ferromagnetic discs 14a, 14b are in contact with the magnetorheological fluid contained in chamber 15. Preferably, said ferromagnetic discs comprise at least one between:
a plurality of rotor discs 14a, which are integral to shaft 13, and
a plurality of stator discs 14b, which are integral to casing 12.

Preferably, rotor discs 14a are mounted so as to be coaxial, to rest against and to rotate together with shaft 13.

Preferably, stator discs 14b are also mounted so as to be coaxial to shaft 13, but they rest against and are fixed in a stationary manner to a spool 20 of casing 12 on which solenoid 16 is wound.

Depending on the intensity of the magnetic field produced by solenoid 16, it can be determined the viscosity of magnetorheological fluid 15. By so doing, the friction force exerted by magnetorheological fluid 15 upon the discs 14a, 14b can be adjusted based on the intensity of said magnetic field. Therefore, the necessary torque to be applied by the user in order to rotate shaft 13 through holding element 11 is determined by the intensity of the magnetic field generated by generating apparatus 16 and by the size of discs 14a, 14b.

More in detail, discs 14a, 14b are placed in a region that contains magnetorheological fluid 15 and are radially contained between shaft 13 and spool 20.

In this embodiment, shaft 13 comprises a pair of half-shafts 13a, 13b, which are coaxial to one another, each half-shaft 13a, 13b peripherally carrying a respective plurality of rotor discs 14a.

FIG. 6a shows an example of rotor disc 14a and an example of stator disc 14b, which preferably carry cuts 29, which extend crosswise but not in a radial direction.

In the embodiment shown, the example of stator disc 14a has a plurality of outer cuts 29a, which are peripherally obtained on it. More in detail, outer cuts 29a originate from the periphery and extend crosswise (in particular, in a non-radial direction) from the outside to the inside.

In the embodiment shown, the example of rotor disc 14b has a plurality of inner cuts 29b, which are centrally obtained on it. More in detail, inner cuts 29b originate from the opening through which shaft 13 rotates and extend crosswise from the inside to the outside.

Cuts 29 allow the haptic feedback to the improved thanks to the dragging action of the magnetorheological fluid between the discs.

In the embodiment shown, at least one between the example of stator disc 14a and the example of rotor disc 14b has a plurality of radial recesses 30, in particular causing disc 14a and/or 14b to have a substantially circumferential toothing. Radial recesses 30 have the advantage of increasing the torque, thus further improving the haptic feedback.

In this embodiment, solenoid 16 is radially arranged between casing 12 and the plurality of discs 14 and is coaxial to casing 12, through spool 20.

In this embodiment, knob 10 further comprises an angular position sensor device, for example an encoder 23, which is configured to detect the angular position assumed by shaft 13 and cooperates with the control device, for example printed circuit board 21. Shaft 13 has a radial recess containing, on the inside, a permanent magnet 24, in particular polarized in a diametrical direction and positioned so as to face encoder 23. Preferably, encoder 23 is configured to transmit a position signal, which indicates the angular position assumed by shaft 13 and, hence, by permanent magnet 24, to printed circuit board 21.

In the embodiment shown, printed circuit board 21 is configured to control the intensity of the electric current passed through solenoid 16 depending on the position signal. In this way, as already explained in detail above, solenoid 16 is configured to generate a magnetic field having an intensity that is adjusted depending on the position assumed by shaft 13, according to predetermined or programmable criteria. As a consequence, the viscosity of the magnetorheological fluid is adjusted by the position assumed by shaft 13 and the discs 14 are designed to exert a friction force that can be adjusted based on said viscosity.

For example, according to some embodiments of the invention, by properly configuring printed circuit board 21 you can obtain at least one of the following results:
blocking shaft 13 in relation to the direction of rotation;
blocking shaft 13 upon reaching a predetermined angular position, which corresponds to a limit stop (or which corresponds to a use condition to be inhibited);
progressively increasing the friction force exerted by assembly 14 upon shaft 13 as shaft 13 is rotated towards a predetermined angular position corresponding to a limit stop (or corresponding to a use condition to be inhibited);
a greater friction, for determining an inertia to the angular movement of shaft 13 upon reaching of a plurality of predetermined angular positions within its rotation range and corresponding to a “discrete” adjustment of an operating parameter or to a “discrete” selection of an operating mode among a plurality of possible alternatives;
a greater friction, for determining an inertia to the angular movement of shaft 13 upon reaching of a plurality of angular positions according to different torque profiles;
a greater friction, for determining an inertia to the angular movement of shaft 13 upon reaching of a plurality of angular positions according to different torque profiles depending on the direction of rotation of the movable portion;
a greater friction, for determining an inertia to the angular movement of shaft 13 upon reaching of a plurality of angular positions and based on the speed of rotation of the movable portion;
a greater friction, for determining an inertia based on the speed of rotation of shaft 13.

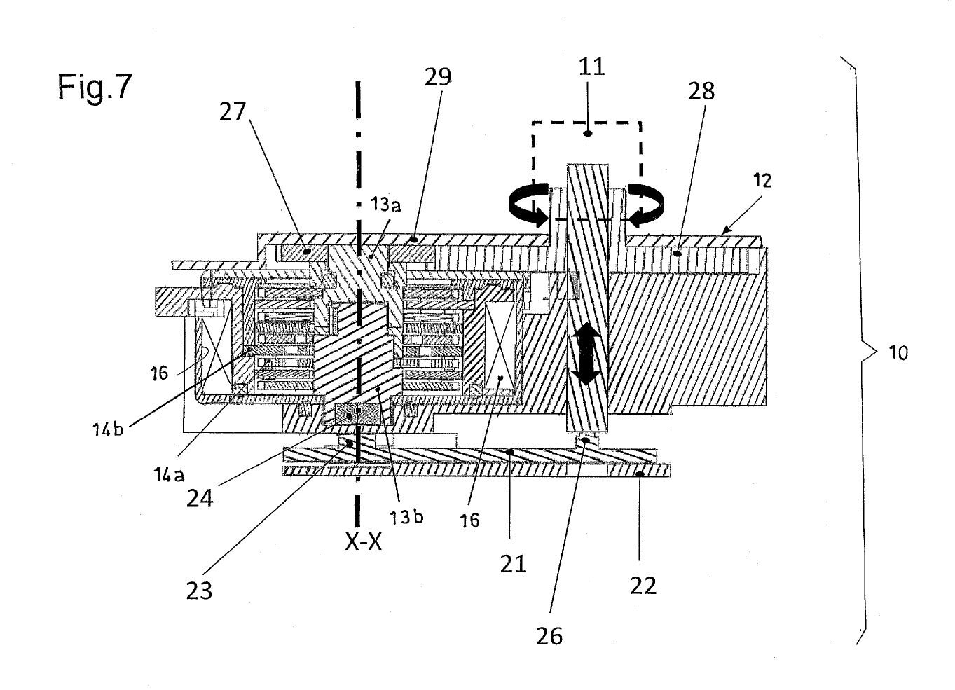

Preferably, as you can see in FIG. 7, encored 23 is mounted on printed circuit board 21, mounted—in turn—on a further support 22 of casing 12, and is optionally magnetic. Preferably, knob 10 comprises a switching member 26, which is mounted so as to translate in a unitary manner relative to holding element 11. In this embodiment, switching member 26 substantially fulfills the function of a mechanical pressure switch.

When users exert a thrust upon holding element 11, they cause a translation of switching member 26 in an axial direction, so as to give an order, thus switching a function in the household appliance with which knob 10 is associated. Switching member 26 is mounted with an axial clearance 29, which allows it to axially slide from a lifted or rest position to a pushed or work position, whereas toothed gear 28 is axially locked. Switching member 26 is designed to cooperate with printed circuit board 21 and, when switching member 26 is in the pushed or work position, it cooperates—in a known manner—with contacts of an associated electrical circuit carried by printed circuit board 21 in order to deactivate or activate a function.

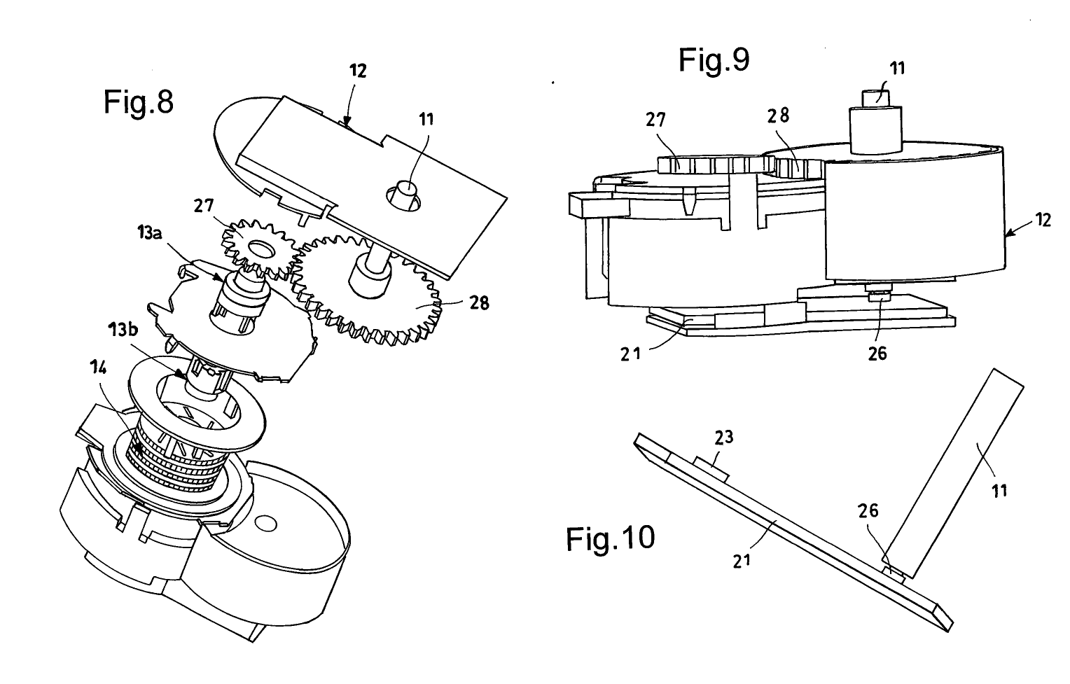

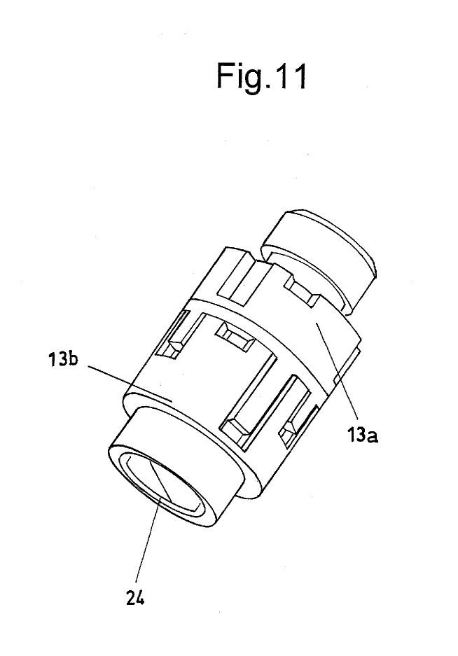

With reference to FIGS. 7 to 11, the drawings show a knob according to a further embodiment of the invention. Elements that are similar or equivalent to the ones of the preceding embodiment are assigned, for the sake of simplicity, the same alphanumeric references and, for the sake of brevity, reference is made to the description above.

In the embodiment shown, switching member 26, for example a so-called “tactile switch”, is carried by printed circuit board 21 and holding element 11 can translate through casing 12 so as to be capable of pushing switching member 26. When users exert a thrust upon holding element 11, it axially translates, pushing switching member 26 so as to give an order, for example switching a function in the household appliance with which knob 10 is associated.

In this embodiment, again, switching member 26 is designed to cooperate with printed circuit board 21. In particular, when switching member 26 is pushed, it can cooperate with contacts of an associated electrical circuit carried by printed circuit board 21 so as to deactivate, activate or adjust a function.

Unlike the preceding embodiment shown with reference to FIGS. 1 to 6, permanent magnet 24 is mounted in an axial recess obtained at the bottom of shaft 13 (instead of at the top thereof).

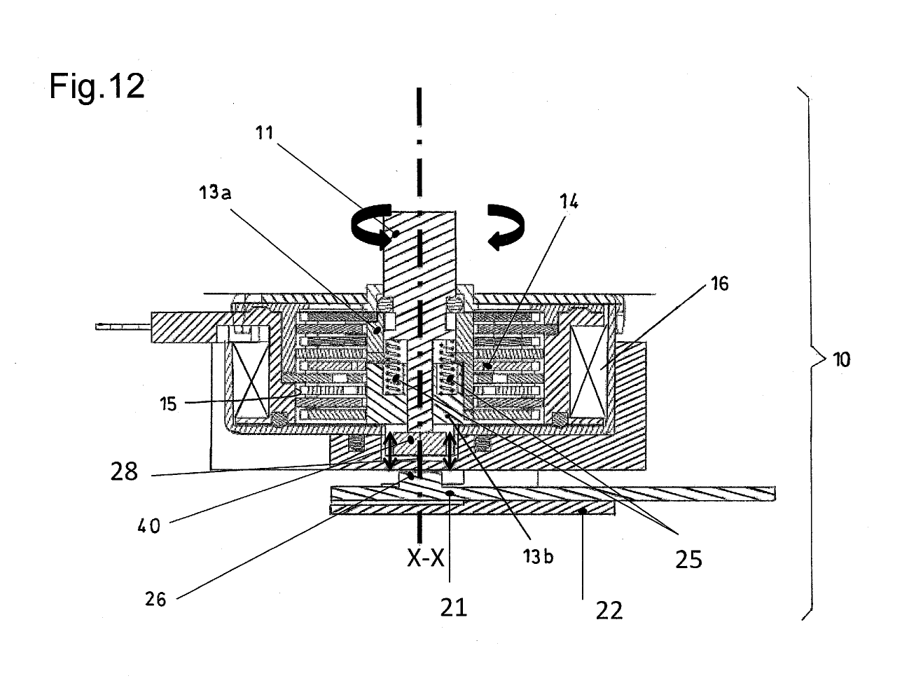

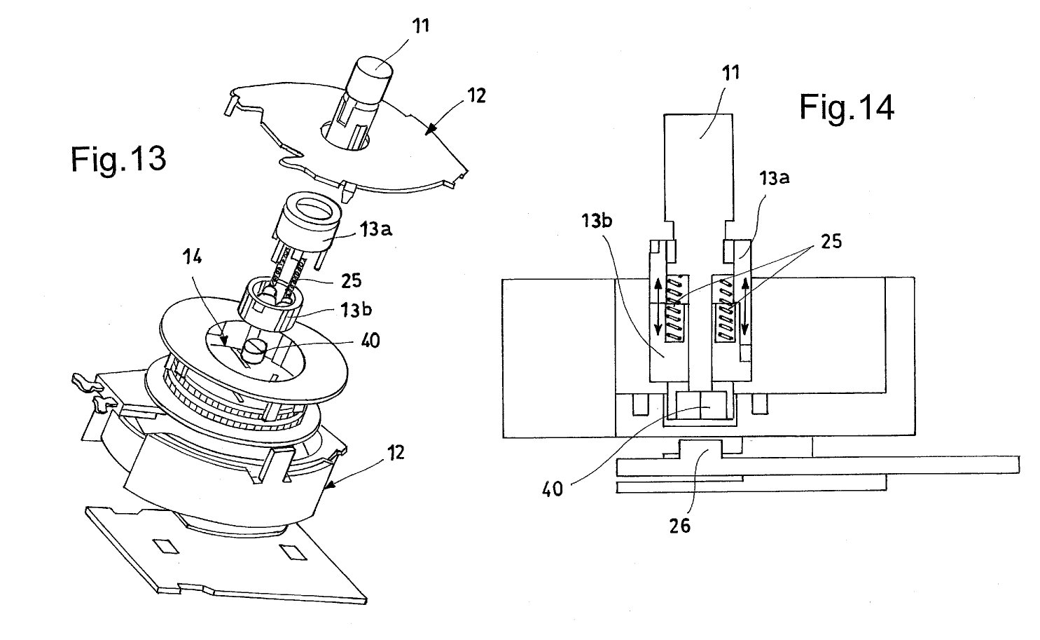

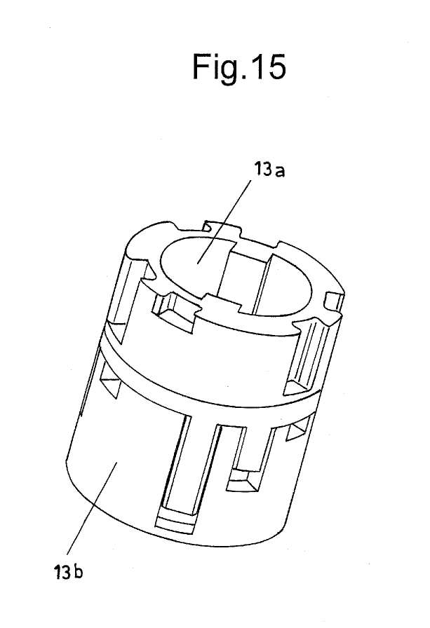

With reference to FIGS. 12 to 15, the drawings show a knob according to a further embodiment of the invention. Elements that are similar or equivalent to the ones of the preceding embodiments are assigned, for the sake of simplicity, the same alphanumeric references and, for the sake of brevity, reference is made to the description above.

In the embodiment shown, holding element 11 and shaft 13 are substantially coaxial to one another, without the presence of the toothed gears 27 and 28 described above.

In the embodiment shown, shaft 13 substantially has the shape of a centrally hollow body for housing a portion of holding element 11.

Holding element 11 is mounted so as to axially translate in shaft 13, but is mounted so as to translate in a unitary manner relative to shaft 13. Furthermore, shaft 13 is capable of rotating around its axis X-X, together with holding element 11.

Between holding element 11 and shaft 13 there is interposed at least one elastic return element, for example a pair of compression-preloaded springs, which tend to hold holding element 11 in a lifted position relative to switching member 26.

In the embodiment shown, switching member 26 is a magnetic sensor, which is configured to detect a magnetic field variation along the axis X-X, whereas holding element 11 carries a permanent magnet 40 facing switching member 26 carried by printed circuit board 21. When holding element 11 is moved to the pushed or work position, permanent magnet 40 is at a distance that is such that switching member 26 cooperates with printed circuit board 21, opening or closing the contacts of an associated electrical circuit (deactivating or activating a function of the device with which knob 10 is associated).

For example, switching member 26 is a Reed contact.

Naturally, the principle of the invention being set forth, embodiments and implementation details can be widely changed relative to what described above and shown in the drawings as a mere way of non-limiting example, without in this way going beyond the scope of protection provided by the accompanying claims.

In the figures we suggested a solenoid as magnetic field generating apparatus. However, in further manufacturing variants, it is possible to use different types of magnetic field generating apparatuses. For example, it is possible to use apparatus including permanent magnets.

In the figures we suggested inclined linear cuts to improve the haptic feedback. However, in further manufacturing variants, it is possible to use different types of cuts. For example, it is possible to use hole-shaped, slot shaped and non-linear cuts.

The figures show an encoder as sensor device for the angular position assumed by the movable portion. However, in further manufacturing variants, it is possible to use different types of angular position transducers.

1. A knob (10), in particular for an electric or electronic apparatus; said knob comprising:
a support structure defining a chamber containing a magnetorheological fluid;
a holding element which is supported in a guided manner by said support structure, is configured to be held by a user and is configured to be rotated and pressed by said user;
a movable portion which is supported, in rotation, by said support structure and is configured to be controlled, in rotation, by said holding element;
a switching member which is movable from a rest arrangement to a work arrangement when said holding element is pressed by said user;
a sensor which is configured to detect the an angular position assumed by said movable portion;
a haptic feedback assembly which is located in said chamber and is configured to act upon said movable portion (13) so as to provide a haptic stimulation in response to the action of said user;
a generating apparatus which is configured to emit a magnetic field, the magnetic field having an intensity capable of affecting the viscosity of said fluid in such a way that said assembly exerts a force upon said movable portion; and
a control device which is configured to determine intensity of said magnetic field depending on predetermined or programmable criteria which are based on at least one between said angular position and said arrangement.

2. A knob according to claim 1, wherein the haptic feedback assembly comprises a plurality of ferromagnetic discs situated in said chamber and in contact with said fluid.

3. A knob according to claim 2, wherein said plurality of ferromagnetic discs comprises a plurality of rotor discs which are mounted to rotate together with the movable portion.

4. A knob according to claim 2, wherein said plurality of ferromagnetic discs comprises a plurality of stator discs which are fixed in a stationary manner with the casing.

5. A knob according to claims 3, wherein said rotor discs are axially interposed to said stator discs.

6. A knob according to claim 2, wherein said discs have transverse cuts.

7. A knob according to claim 2, wherein said discs have radial recesses.

8. A knob according to claim 1, wherein said switching member is mounted so as to move in a guided manner relative to the holding element.

9. A knob according to claim 1, wherein said switching member is mounted on said control device.

10. An interface structure comprising a knob according to claim 1.

11. An electric or electronic apparatus comprising an interface structure according to claim 10.
